(19) United States
(12) Patent Application Publication
(10) Pub. No.: US 2025/0306982 A1
(43) Pub. Date: Oct. 2, 2025

(54) SYSTEMS AND METHODS FOR DETERMINING AND RESOLVING INTERRUPTIONS TO COMPUTING COMPONENTS

(71) Applicant: BANK OF AMERICA CORPORATION, Charlotte, NC (US)

(72) Inventors: George Anthony Albero, Charlotte, NC (US); Maharaj Mukherjee, Poughkeepsie, NY (US); Lakshmi Narasimman, Chennai (IN)

(73) Assignee: BANK OF AMERICA CORPORATION, Charlotte, NC (US)

(21) Appl. No.: 18/620,383

(22) Filed: Mar. 28, 2024

(51) Int. Cl. G06F 9/48

(52) U.S. Cl. CPC G06F 9/4818; G06F 9/4881

(57) ABSTRACT

Systems, computer program products, and methods are described herein for determining and resolving interruptions to computing components. The present disclosure is configured to identify an interruption(s) and a potential response computing component(s); generate a Bi-Partite knowledge graph comprising the interruption(s) within a interruption priority queue(s) and the potential response computing component(s) within a response priority queue(s), wherein the Bi-Parte knowledge graph comprises a relational edge between the interruption priority queue(s) and the response priority queue(s); dynamically update the Bi-Partite knowledge graph with the interruption priority queue(s) based on an interruption factor(s) and the response priority queue(s) based on potential response factor(s); select, based on the updated interruption priority queue(s) and the updated response priority queue(s), a priority interruption and a priority potential response computing component; and resolve the priority interruption with the priority response computing component.

### TECHNOLOGICAL FIELD

Example embodiments of the present disclosure relate to determining and resolving interruptions to computing components.

### BACKGROUND

In complex technology infrastructural computing systems any malfunctioning software or hardware components can have far reaching and long-term impacts if not resolved quickly and efficiently. Additionally, and in these complex technology infrastructural computing systems, multiple interruptions could occur at one time making the process of resolving all the interruptions time-consuming and difficult to sort through to prioritize. Thus, there exists a need for a system, computer program produce, and/or computer-implemented method that can efficiently, dynamically, and automatically determine and resolving interruptions to computing components, especially in a complex technology infrastructural computing system.

Applicant has identified a number of deficiencies and problems associated with determining and solving interruptions to computing components including hardware and software components. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for determining and resolving interruptions to computing components.

In one aspect, a system for determining and resolving interruptions to computing components is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: identify at least one interruption and at least one potential response computing component; generate a Bi-Partite knowledge graph comprising the at least one interruption within at least one interruption priority queue and the at least one potential response computing component within at least one response priority queue, wherein the Bi-Parte knowledge graph comprises a relational edge between the at least one interruption priority queue and the at least one response priority queue; dynamically update the Bi-Partite knowledge graph with the at least one interruption priority queue based on at least one interruption factor and the at least one response priority queue based on at least one potential response factor; select, based on the updated at least one interruption priority queue and the updated at least one response priority queue, a priority interruption and a priority potential response computing component; and resolve the priority interruption with the priority response computing component.

In some embodiments, the at least one interruption is associated with at least one computing component.

In some embodiments, executing the computer-readable code is configured to cause the at least one processing device to: identify a pre-defined priority for the at least one interruption; and update the Bi-Partite knowledge graph with the at least one interruption priority queue based on the pre-defined priority.

In some embodiments, executing the computer-readable code is configured to cause the at least one processing device to: determine whether the at least one interruption is associated with a plurality of interruptions; and shift up, in an instance where the at least one interruption is associated with the plurality of interruptions, the at least one interruption in the at least one interruption priority queue.

In some embodiments, the at least one interruption factor comprises an assigned priority, a computed priority, a workaround, time to resolution, previous responses, or a root cause analysis.

In some embodiments, the Bi-Partite knowledge graph comprise at least one potential response factor associated with the at least one potential response computing component, and wherein the at least one potential response factor comprises a current usage, an available capacity, a system stability, a required maintenance, a scheduled maintenance, an obsolescence, or a vulnerability.

In some embodiments, executing the computer-readable code is configured to cause the at least one processing device to: identify at least one pre-determined interruption parameter for the at least one interruption, wherein the at least one pre-determined interruption parameter comprises at least one application impacted, a pre-defined priority, or a pre-defined maximum downtime; and update the Bi-Partite knowledge graph with the at least one interruption priority queue based on the at least one pre-determined parameter.

In some embodiments, executing the computer-readable code is configured to cause the at least one processing device to: identify at least one pre-determined potential response parameter, wherein the at least one pre-determined potential response parameter comprises an ownership, a capacity, an availability, an operating system, a current usage role, or a security level.

In some embodiments, the Bi-Partite knowledge graph comprises a plurality of interruption priority queues and a plurality of response priority queues.

In some embodiments, executing the computer-readable code is configured to cause the at least one processing device to: update, based on resolving the priority interruption with the priority response computing component, the Bi-Partite knowledge graph comprising the updated at least one interruption priority queue without the priority interruption and the updated at least one response priority queue without the priority response computing component; and select a priority interruption and a priority potential response computing component from the updated Bi-Partite knowledge graph.

Similarly, and as a person of skill in the art will understand, each of the features, functions, and advantages provided herein with respect to the system disclosed hereinabove may additionally be provided with respect to a computer-implemented method and computer program product.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining and resolving interruptions to computing components, in accordance with an embodiment of the disclosure;

FIG. 2 illustrates a process flow for determining and resolving interruptions to computing components, in accordance with an embodiment of the disclosure;

FIG. 3 illustrates a process flow for updating the Bi-Partite knowledge graph with the interruption priority queue based on a pre-defined priority, in accordance with an embodiment of the disclosure;

FIG. 4 illustrates a process flow for shifting the interruption within the interruption priority queue, in accordance with an embodiment of the disclosure;

FIG. 5 illustrates a process flow for updating the Bi-Partite knowledge graph with the interruption priority queue based on the pre-determined parameter, in accordance with an embodiment of the disclosure;

FIG. 6 illustrates a process flow for identifying a pre-determined potential response parameter, in accordance with an embodiment of the disclosure;

FIG. 7 illustrates a process flow for selecting a priority interruption and a priority potential response computing component from an updated Bi-Partite knowledge graph, in accordance with an embodiment of the disclosure; and

FIGS. 8A-8B illustrates exemplary Bi-Partite knowledge graphs, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In complex technology infrastructural computing systems any malfunctioning software or hardware components can have far reaching and long-term impacts if not resolved automatically and efficiently. Additionally, and in these complex technology infrastructural computing systems, multiple interruptions could occur at one time making the process of resolving all the interruptions time-consuming and difficult to sort through to prioritize. Thus, there exists a need for a system, computer program produce, and/or computer-implemented method that can efficiently, dynamically, and automatically determine and resolving interruptions to computing components, especially in a complex technology infrastructural computing system.

In order to solve these identified problems and other related issues, the present disclosure provides for identifying one or more interruptions (such as an interruption to a computer hardware or software component) and at least one potential response computing component (e.g., such as a hardware or software component, process, and/or the like, that may resolve the interruption(s)); and generating a Bi-Partite knowledge graph comprising the at least one interruption within at least one interruption priority queue and the at least one potential response computing component within at least one response priority queue, wherein the Bi-Parte knowledge graph comprises a relational edge (e.g., such that the data between the knowledge graphs within the Bi-Partite knowledge graph can be dependently updated) between the at least one interruption priority queue and the at least one response priority queue. Additionally, the present disclosure further provides for dynamically updating the Bi-Partite knowledge graph with the at least one interruption priority queue based on at least one interruption factor and the at least one response priority queue based on at least one potential response factor; selecting, based on the updated at least one interruption priority queue and the updated at least one response priority queue, a priority interruption (e.g., a highest rated interruption that should be prioritized first for solving) and a priority potential response computing component (e.g., a highest rated computing component that is ready, available, and capable of solving the priority interruption); and resolve the priority interruption with the priority response computing component.

In other words, the present disclosure provides a system, computer program product, and a computer-implemented method for determining priority of interruptions (e.g. events) to a computing systems, based on generating a Bi-Partite knowledge graph which analyzes a set of all the interruption events identified and all of the computing resources available within each graph. Such a Bi-Partite knowledge graph is then updated regularly and dynamically based on (1) factors for the identified interruptions (e.g., assigned and computed priorities, root cause analysis, and time to resolutions including any workarounds available and known) and (2) factors for the computing resources (e.g., types of available resources, availability and bandwidth, ownership, capacity, cloud based, and/or the like). Additionally, and between each of the two graphs, data may be transmitted regarding current requests for particular resources to solve each interruption as it moves to the top of the knowledge graph (e.g., is highest priority) and which resource is ultimately selected. Based on the current state of the resources available (i.e., computing components capable of resolving the interruption(s)) and the current state of interruptions not resolved, the knowledge graphs on each side will update dynamically and automatically to move the highest priority interruption and highest priority resource available to the top to be dealt with next. In this manner, each knowledge graph will have its own dynamic tree updates based on a priority queue based algorithm.

What is more, the present disclosure provides a technical solution to a technical problem. As described herein, the technical problem includes the efficient and automatic determination and resolving of interruptions to computing components. The technical solution presented herein allows for the efficient, dynamic, and automatic determination and solution to interruptions to computing components. In particular, present disclosure is an improvement over existing solutions to solving interruptions in a computing environment, (i) with fewer steps to achieve the solution, thus reducing the amount of computing resources, such as processing resources, storage resources, network resources, and/or the like, that are being used (e.g., by automatically, dynamically, and efficiently generating, updating, and maintaining dynamic trees within a Bi-Partite knowledge graph comprising all the known interruptions and all the known potential response computing components and selecting-automatically-therefrom the method to resolve the interruption(s)); (ii) providing a more accurate solution to problem, thus reducing the number of resources required to remedy any errors made due to a less accurate solution (e.g., based on interruption parameters and potential response parameters which dynamically update the interruption priority queues and the response priority queues); (iii) removing manual input and waste from the implementation of the solution, thus improving speed and efficiency of the process and conserving computing resources (e.g., by automatically updating the Bi-Partite knowledge graph and its associated data); (iv) determining an optimal amount of resources that need to be used to implement the solution, thus reducing network traffic and load on existing computing resources (e.g., by selecting—automatically—the best response computing component to handle each interruption, which is based on interruption factors and potential response factors). Furthermore, the technical solution described herein uses a rigorous, computerized process to perform specific tasks and/or activities that were not previously performed. In specific implementations, the technical solution bypasses a series of steps previously implemented, thus further conserving computing resources.

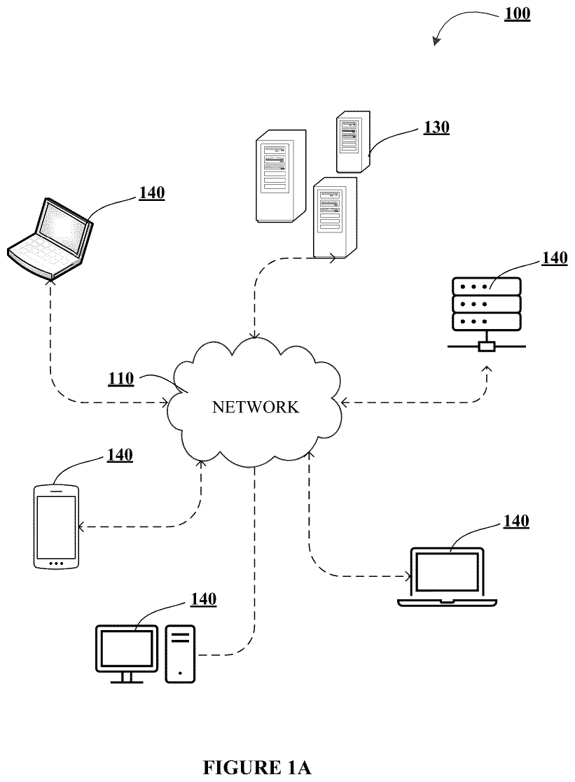

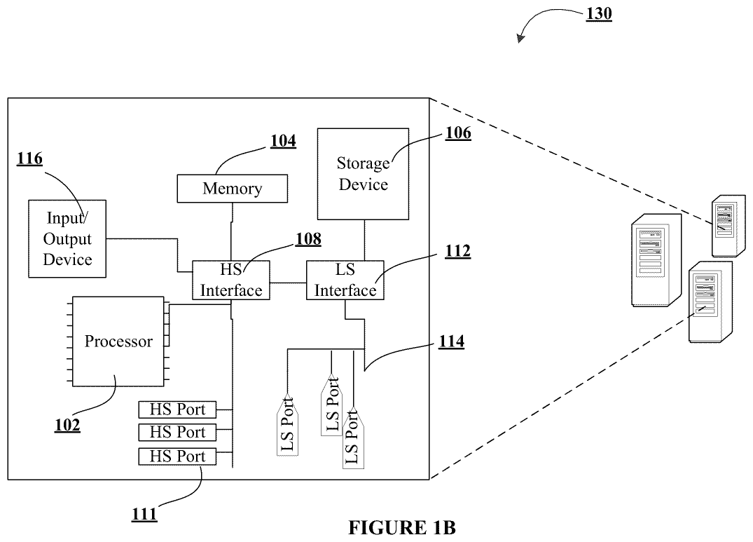

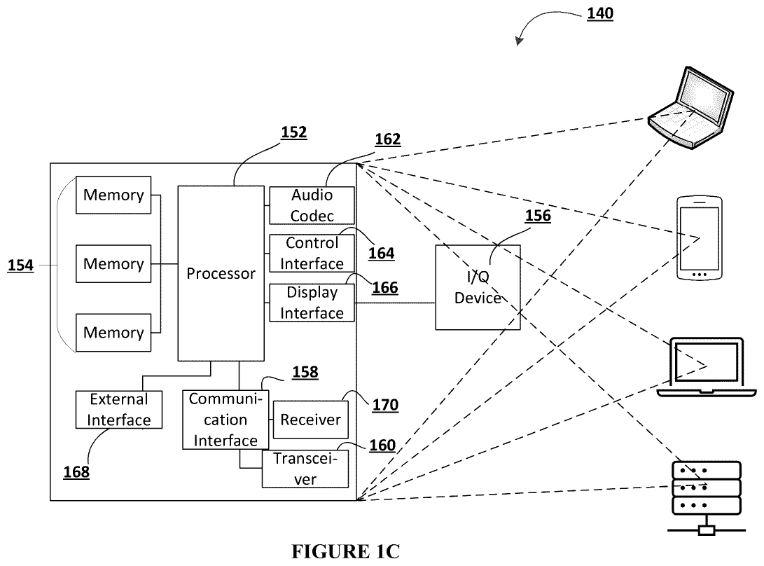

FIGS. 1A-1C illustrate technical components of an exemplary distributed computing environment for determining and resolving interruptions to computing components 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

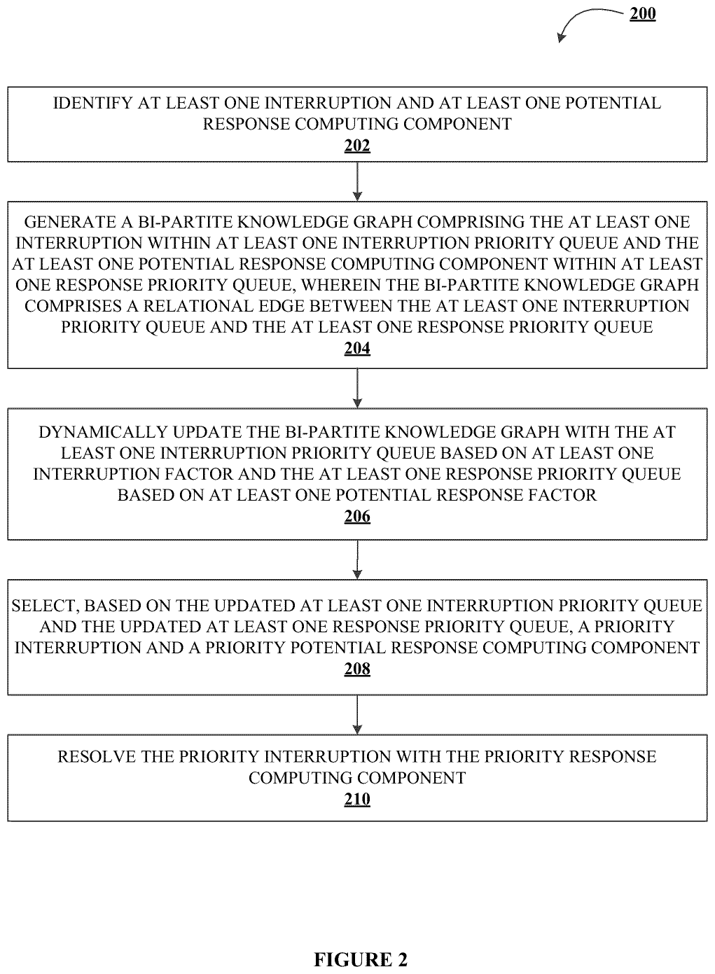

FIG. 2 illustrates a process flow 200 for determining, managing, and securing data in federated data channels, in accordance with an embodiment of the disclosure. steps of process 200. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process flow 200.

FIG. 2 illustrates a process flow 200 for determining, managing, and securing data in federated data channels, in accordance with an embodiment of the disclosure. steps of process 200. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process flow 200.

FIG. 2 illustrates a process flow 200 for determining, managing, and securing data in federated data channels, in accordance with an embodiment of the disclosure. steps of process 200. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process flow 200.

As shown in block 202, process flow 200 may include the step of identifying at least one interruption and at least one potential response computing component. For instance, the system may identify an interruption within a computing environment based on identifying an interruption to the normal functioning of a hardware of software component (such as an application, a storage database, and/or the like) within the computing environment. For example, the system may identify at least one or more interruptions to at least one hardware and/or software component by determining that the hardware and/or software component are not functioning normally or optimally. Further, the system may additionally identify at least one potential response computing component, whereby the potential response computing components refers to a computing component (e.g., hardware and/or software component) that can potentially resolve the identified interruption(s) or other such identified interruption(s) (such as those interruptions identified and discussed in further detail below).

In some embodiments, the system may receive an interruption identifier or an event identifier (such as a ticket comprising event data for the interruption) that identifies the interruption, its data, its location, and/or the like). In some embodiments, the interruption identifier and/or event identifier may comprise data regarding other interruptions that are affected by the primary interruption (e.g., those computing components that are likewise interrupted because of the primary interruption).

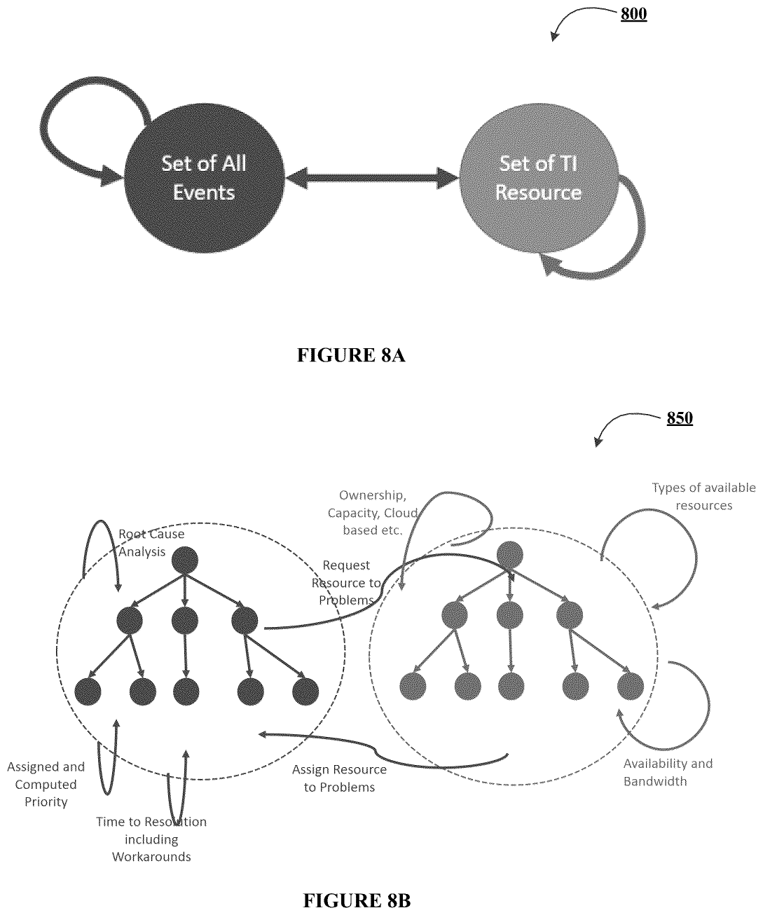

As shown in block 204, the process flow 200 may include the step of generating a Bi-Partite knowledge graph comprising the at least one interruption within at least one interruption priority queue and the at least one potential response computing component within at least one response priority queue, wherein the Bi-Partite knowledge graph comprises a relational edge between the at least one interruption priority queue and the at least one response priority queue. As used herein, a Bi-Partite knowledge graph (or BiGraph knowledge graph) refers to a graph whose vertices are divided into two disjoint and independent sets. In this manner, the Bi-Partite knowledge graph may comprise multiple sets of interruptions on one side and multiple potential response computing components on the other side, whereby each side is independently and dynamically updated to determine a highest priority interruption and a highest priority potential response computing component. Such an exemplary Bi-Partite knowledge graph is shown and described below with respect to FIGS. 8A and 8B.

In some embodiments, the system may generate the Bi-Partite knowledge graph to comprise the at least one interruption by placing the at least one interruption within at least one interruption priority queue. As used herein, each interruption priority queue comprises a dynamic tree of at least one interruption(s) organized based on at least one interruption factor(s) associated with each interruption which is used to generate a priority level for each interruption. In this manner, the Bi-Partite knowledge graph may comprise a one or more interruption priority queues, whereby the greatest priority level of the interruption priority queue(s) will be resolved first. In some embodiments, the Bi-Partite knowledge graph may comprise a plurality of interruption priority queues and/or a plurality of response priority queues, which may be separated and organized to indicate the skill and ability need to resolve the interruptions within each interruption queue and the skill and ability within each response priority queue. In some embodiments, each interruption priority queue may be organized based on the affected or impacted application(s) and their relationships with other impacted application(s) (such as where an interruption is a root cause of other interruptions). Additionally, and such a dynamic tree(s) may automatically and dynamically update based on the interruption factor(s), which are used to determine the current priority level of each interruption. Such interruption factors may comprise but are not limited to an assigned priority, a computed priority, a workaround (e.g., whether a workaround exists), a time to resolution, a previous response(s), and/or a root cause analysis.

Such an assigned priority may be pre-assigned by the system itself (e.g., based on previous instances of the interruption and/or similar interruptions to the computing component affected or the type of interruption involved), an agent of the system, a client of the system (e.g., such as a client managing the computing component affected by the interruption), and/or the like. Additionally, a computed priority may comprise a priority that is determined based on external data to the interruption, such as but not limited to interruption time (e.g., the time that has passed since the initial down time or interruption time). In some embodiments, the computed priority may be used to update the assigned priority (e.g., the longer the interruption has gone unresolved, the greater the assigned interruption will be manipulated to a higher level or numerical value). In some embodiments, a maximum downtime may be pre-determined and assigned to each interruption and used to determine the level or numerical value of the interruption(s) in the interruption priority queue. Thus, and where the downtime of an instant interruption is greater than the assigned maximum downtime, the system—through the interruption priority queue—may move the instant interruption to the top interruption in the interruption priority queue, which indicates the instant interruption should be resolved first.

Additionally, the workaround factor may comprise a determination of whether a workaround is available for the interruption (e.g., whether a workaround has been previously used and has worked for a previous interruption that matches the current interruption). In some embodiments, such a workaround may not require any response computing components listed in the Bi-Partite knowledge graph, and thus can be resolved without using up any of the potential response computing components. Further, a time to resolution factor may be used in combination with the workaround factor, such that the time to resolution factor is generated or determined based on the previous solutions employed and their time to resolution. Thus, and in some embodiments where a workaround is present, the workaround may be selected for current interruption based on determining that the time to resolution is short. However, and where the time to resolution is determined to have been too slow, such a workaround may be ignored for a faster resolution method (one not using the workaround identified).

Further, a root cause analysis factor may comprise a determination that the instant interruption is caused by another interruption and/or whether the instant interruption is causing other interruptions within the computing system environment. In this manner, and if the instant interruption is causing other interruptions (i.e., is a root cause), then the system may determine the root cause analysis factor should be of a higher value or level (indicating the instant interruption should be handled sooner rather than later). Similarly, and where the instant interruption is caused by another interruption, then the system may determine the root cause interruption (e.g., the interruption causing the instant interruption) should be of a higher value or level for the root cause analysis factor. In some embodiments, and the determination of whether a workaround exists may be used to lessen or add to the root cause analysis factor value or level. In this manner, each of the interruption factors listed are dependent on each other and may be used dynamically to update the other interruption factors.

Thus, and as used herein, the dynamic tree(s) of the interruption priority queue are based on each of the interactions between the interruption factor(s), and the top-most or greatest priority interruption may be moved to the top of the dynamic tree for resolution first before moving onto any of the other interruptions within the interruption priority queue(s). In this manner, the interruption priority queue(s) of the Bi-Partite knowledge graph comprises all the interruptions that have not yet been resolved, and each of the interruptions are ranked from lowest priority to highest priority and the highest priority interruption is resolved first before moving onto another highest priority interruption (which may dynamically and in real-time change as the system completes the analysis described herein regularly).

Similar to the interruption priority queue, the Bi-Partite knowledge graph may additionally comprise at least one response priority queue(s) which likewise is automatically and dynamically updated based on potential response factor(s) for each potential response computing component(s) within the response priority queue(s). As used herein, the response priority queue comprises a dynamic tree that automatically and dynamically updates to show the priorities of each potential response computing component, and determines the potential response computing component with the highest priority which can be used to resolve the highest priority interruption of the interruption priority queue(s). Such a response priority queue may be updated based on potential response factor(s), which may comprise but are not limited to a current usage, an available capacity, a system stability, a required and a scheduled maintenance, an obsolescence, and/or a vulnerability.

Thus, and as used herein, the current usage factor refers to the current usage (such as current power usage/consumption) for the potential response computing component within the response priority queue. In this manner, the system may be more inclined to use a potential response computing component that is not currently using a lot of power. In this manner, the system can pick and choose the potential response computing component to resolve the highest priority interruption without overburdening response computing components that are already overused. Additionally, the system may analyze the available capacity factor of each potential response computing component to determine a current availability for each potential response computing component and determine which potential response computing components are most currently available to handle an interruption. As used herein, the available capacity of the response computing component is based on the computing component's storage capacity at a current time (such as the time the dynamic tree is being updated). In some embodiments, the availability capacity factor may additionally and/or alternatively be based on the computing component's availability, which is further determined based on the computing component's run time (e.g., how long the computing component is running/performing an action) divided by the run time and total downtime. Such an availability metric may be used to determine how often and/or at what times the potential response computing component is fully operational and can be used to resolve an interruption. In some embodiments, the current usage and availability factors may be combined for a single factor which is dependent on each other to determine a single current usage and availability capacity factor.

As used herein, the system stability factor is based on whether expected outputs by the computing components occur regularly and as expected. For example, and based on whether the output of each potential response computing component is taken and compared to an expected or intended output, the system can determine whether the potential response computing component is stable. The greater the system stability factor, the more stable the potential response computing component is. Additionally, the required maintenance and scheduled maintenance factors refer to any required maintenance that is preventative and periodically-routine, respectfully. In some embodiments, the system stability factor, and the required and scheduled maintenance factors may be dependent on each other and may be affected by the other factor(s), and/or may be clustered together.

As used herein, the obsolescence factor refers to the determination of whether each potential response computing component is obsolete or outdated, such that it is no longer used. In some embodiments, and based on a determination that a potential response computing component is obsolete, then the obsolescence factor may be of a lower value and/or a lower level. As used herein, the vulnerability factor refers to the determination of potential or determined flaw or weakness for each potential response computing component, such a vulnerability may occur due to security procedures, design flaws, implementation flaws, control flaws, and/or the like. In some embodiments, the obsolescence factor and the vulnerability factor may be dependent on each other and may be affected by the other factor(s), and/or may be clustered together.

Additionally, and in some embodiments, a security protocol, requirement, and/or the like may be considered as a factor for the potential response computing components. In some such embodiments, and where a security protocol of a potential response computing component requires a particular user, a particular database that is protected by a separate security protocol, and/or the like, then the system may use a potential response computing component with less security requirements to resolve an interruption. In this manner, and where a security protocol is too difficult to meet for a potential response computing component, then the system may use a different/secondary response computing component that has less security requirements (which may in turn lead to a quicker downtime for resolving the interruption).

Additionally, and in some embodiments, each side of the Bi-Partite knowledge graph may comprise multiple dynamic trees for the response priority queue and/or the interruption priority queue.

In some embodiments, at least one relational edge may be used between each side of the Bi-Partite knowledge graph, and may be used to transmit information and data between each side such that each side be updated regularly and dynamically. For instance, and upon generating and/or updating the interruption priority queue(s) and the response priority queue(s) within the Bi-Partite knowledge graph, the relational edge may be used to indicate which interruption has the highest priority and which potential response computing component has the highest priority, and therefore match the potential response computing component to resolve the interruption.

As shown in block 206, the process flow 200 may include the step of dynamically updating the Bi-Partite knowledge graph with the at least one interruption priority queue based on at least one interruption factor and the at least one response priority queue based on at least one potential response factor. For example, the system may dynamically update the Bi-Partite knowledge graph by updating the interruption priority queue(s) and the response priority queue(s) based on the interruption factor(s) and the potential response factor(s). Such a dynamic updating may occur regularly and upon each update to each interruption factor(s) and/or each update to each potential response factor(s). As used herein, the interruption factor(s) and the potential response factor(s) are used to update the dynamic tree(s) of the interruptions in the Bi-Partite knowledge graph and the potential response computing component in the Bi-Partite knowledge graph, respectively.

As shown in block 208, the process flow 200 may include the step of selecting, based on the updated at least one interruption priority queue and the updated at least one response priority queue, a priority interruption and a priority potential response computing component. As used herein, the priority interruption refers to the interruption with the highest priority level and/or value, and the priority potential response computing component refers to the potential response computing component with the highest priority level and/or value. For instance, the system may select—from the updated interruption priority queue(s) and the updated response priority queue(s) in the Bi-Partite knowledge graph-a highest priority (e.g., highest priority level or value) interruption of the interruption priority queue(s) and the highest priority response computing component of the potential response computing components in the response priority queue. In this manner, the system may automatically select the interruption with the highest priority level or value which indicates that selected interruption needs to be dealt with and resolved first. Similarly, the system may also automatically select the potential response computing component with the highest priority level or value which indicates that the selected response computing component is the best option to resolve the interruption.

As shown in block 210, the process flow 200 may include the step of resolving the priority response computing component. For instance, the system may resolve—by applying the priority potential response computing component to the priority interruption—the priority interruption efficiently, automatically, and by using the potential response computing component with the availability and capability to do so. As used herein, the term resolve refers to the resolution of the identified interruption, such that the associated computing component(s) affected by the interruption are returned to regular and normal working order.

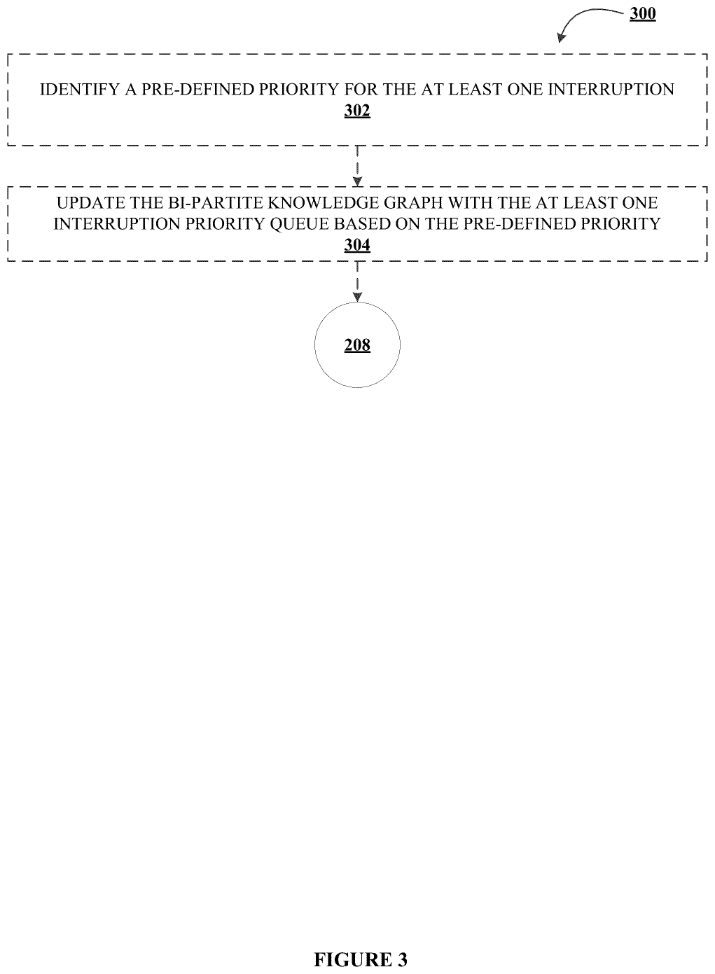

FIG. 3 illustrates a process flow 300 for updating the Bi-Partite knowledge graph with the interruption priority queue based on a pre-defined priority, in accordance with an embodiment of the disclosure. In some embodiments, a system (e.g., similar to one or more of the systems described herein with respect to FIGS. 1A-1C and 2) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of identifying a pre-defined priority for the at least one interruption. For example, and in some embodiments, the system may identify a pre-defined priority for the at least one interruption, whereby the pre-defined priority maybe pre-defined by a manager of the system, a client of the system, the system itself, and/or the like. In some embodiments, the pre-defined priority may be based on the level of importance of the affected computing component associated with the interruption. In some embodiments, the pre-defined priority may be based on the interruption itself (such as an interruption type), which may be identified by the system itself and compared to a list and/or index of pre-defined priorities assigned to different interruption types. In some embodiments, the interruption type may comprise a security breach interruption, a resource transaction interruption, a storage interruption, and/or the like.

In some embodiments, and as shown in block 304, the process flow 300 may include the step of updating the Bi-Partite knowledge graph with the at least one interruption priority queue based on the pre-defined priority. For instance, and in some embodiments, the system may update—based on the pre-defined priority—the Bi-Partite knowledge graph and its dynamic tree(s) associated with the interruptions. In this manner, the side of the Bi-Partite knowledge graph comprising the interruption priority queue(s) may be automatically updated to account for any pre-defined priority, such that in an instance where a pre-defined priority is assigned to an interruption, the interruption may shift up or down in the associated interruption priority queue (depending on the pre-defined priority assigned). In this manner, and in some embodiments, the pre-defined priority may comprise a value that increases or decreases the priority level or value for the interruption in its interruption priority queue.

Additionally, and in some embodiments, once the update to the interruption priority queue has occurred, the system may resolve the priority interruption of the updated interruption priority queue with the priority response computing component, similar to the process described with respect to block 210 of FIG. 2.

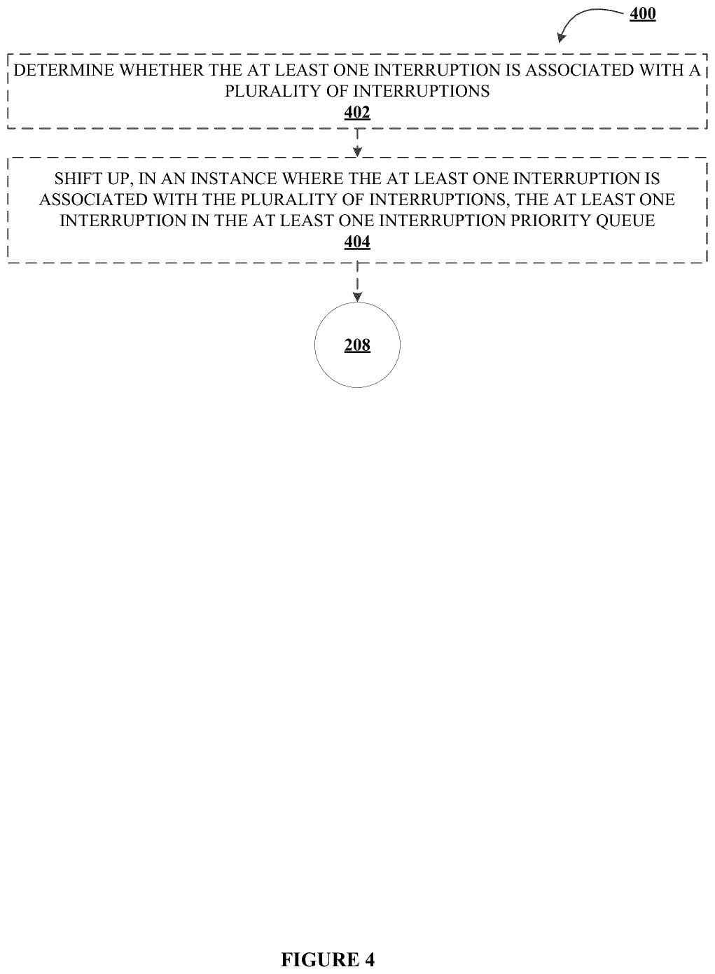

FIG. 4 illustrates a process flow 400 for shifting the interruption within the interruption priority queue, in accordance with an embodiment of the disclosure. In some embodiments, a system (e.g., similar to one or more of the systems described herein with respect to FIGS. 1A-1C and 2) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of determining whether the at least one interruption is associated with a plurality of interruptions. For instance, and in some embodiments, the system may determine whether any of the identified interruptions are associated with a plurality of interruptions, thus indicating that a root cause has occurred and caused a plurality of interruptions. In some embodiments, the root cause interruption may be traced back by analyzing each of the affected interruptions and determining which interruption occurred first.

In some embodiments, and as shown in block 404, the process flow 400 may include the step of shifting up—in an instance where the at least one interruption is associated with the plurality of interruptions—the at least one interruption in the at least one interruption priority queue. For example, and in some embodiments, the system may shift up the interruption identified as the root cause interruption in the interruption priority queue. In this manner, and in some embodiments, the root cause interruption may be shifted up so the system can resolve the root cause interruption earlier and before other interruptions that are not root cause interruptions. In some embodiments, the shifting up of the root cause interruption may cause the root cause interruption to become the priority interruption that is resolved next by a priority response computing component.

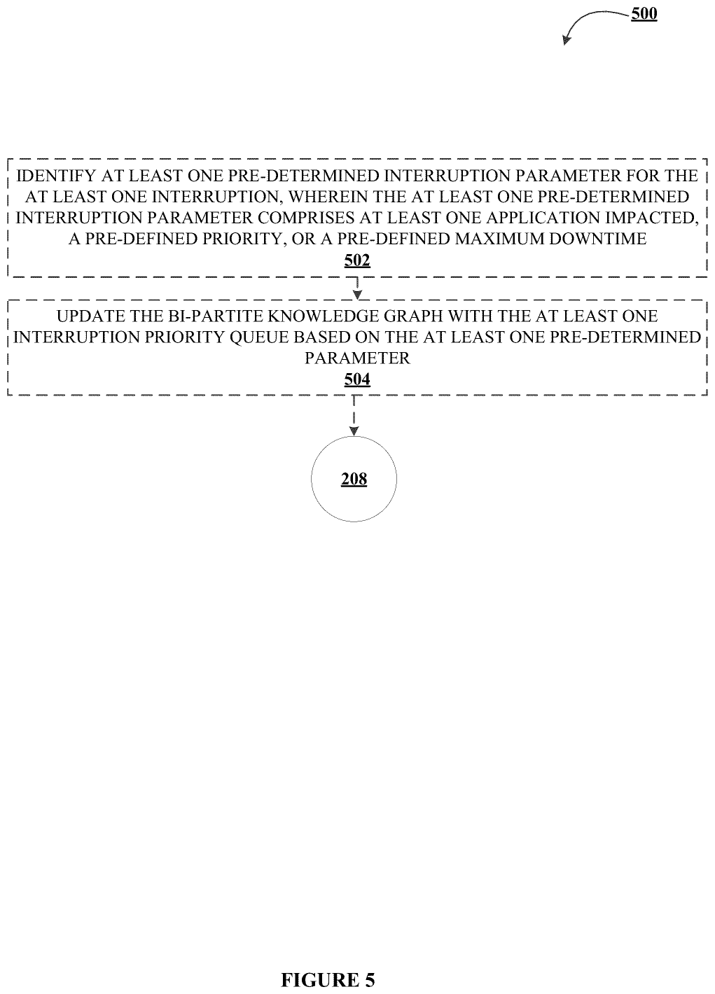

FIG. 5 illustrates a process flow 500 for updating the Bi-Partite knowledge graph with the interruption priority queue based on the pre-determined parameter, in accordance with an embodiment of the disclosure. In some embodiments, a system (e.g., similar to one or more of the systems described herein with respect to FIGS. 1A-1C and 2) may perform one or more of the steps of process flow 500. For example, a system (e.g., the system 130 described herein with respect to FIG. 1A-1C) may perform the steps of process 500.

In some embodiments, and as shown in block 502, the process flow 500 may include the step of identifying at least one pre-determined interruption parameter for the at least one interruption, wherein the at least one pre-determined interruption parameter comprises at least one application impacted, a pre-defined priority, or a pre-defined maximum downtime. For instance, and in some embodiments, the system may identify whether at least one pre-determined interruption parameter is present for each interruption. In some embodiments, the pre-determined parameter(s) may comprise one of an application impacted, a pre-defined priority, and/or a pre-defined maximum downtime. In an instance where a pre-determined parameter is present and identified for an interruption, then the system may update the interruption priority queue based on the pre-determined parameter (such as by shifting the interruption with the at least one pre-determined interruption parameter up).

As used herein, the application impacted parameter may comprise data of particular applications that when impacted by an interruption should prioritize the interruption as needing to be resolved quickly. For instance, and where an application impacted is important to the overall computing system, important to the client of the system, identified as important to a client's intent and purpose (such as an application associated with allowing resource transactions where the client is a financial institution), then the system may determine that the interruption causing the impact to such an important application needs to be resolved next out of all the rest of the interruptions identified. In some embodiments, the pre-defined application impacted parameter may be identified by the system based on accessing a database of application impacted parameters, an index of application impacted parameters, and/or the like, and comparing the application(s) actually impacted by an interruption to the application impacted parameters to determine whether there is a match (e.g., application impacted parameter is met for the interruption). In some such embodiments, the comparison and determination of a match may be done by comparing application identifiers between the application impacted parameter and the actual application(s) impacted.

Additionally, and as used herein, the pre-defined priority may comprise a pre-defined level and/or value for specified interruptions. In this manner, the system may identify whether an interruption has a pre-defined priority that should be applied within the interruption priority queue. Such interruptions with a pre-defined priority may indicate the interruptions are important to the overall computing system, important to the client's purpose or intent, and/or the like. In some embodiments, the pre-defined priority may be determined by the system by comparing an interruption type and/or an application impacted identifier against an index and/or database of pre-determined interruption types and/or pre-determined application(s) impacted associated with a pre-defined priority(ies). In this manner, the system may compare the interruption type and/or application impacted identifier for an interruption against an index and/or database of pre-determined interruptions types and/or pre-determined application(s) impacted with pre-defined priority(ies) and determine whether there are any matches, and where there are matches with a currently identified interruption, apply a the pre-defined priority to the interruption within the interruption priority queue.

As used herein, the pre-defined maximum downtime parameter may comprise a pre-determined downtime for an associated interruption's impacted application(s) and/or affected hardware component(s), whereby once the pre-defined maximum downtime has been met, the associated interruption will be shifted up in the interruption priority queue. In this manner, and once the pre-defined maximum downtime has been met for an interruption, the system may automatically shift up the interruption in the interruption priority queue to the top of the interruption priority queue and indicate that the interruption should be resolved next. In some embodiments, each interruption may have its own pre-defined maximum downtime which may be measured from the time the interruption is identified. In some embodiments, the pre-defined maximum downtime may be standard for all interruptions unless otherwise indicated by the system itself, by a manager of the system, by a client of the system, and/or the like.

In some embodiments, and as shown in block 504, the process flow 500 may include the step of updating the Bi-Partite knowledge graph with the at least one interruption priority queue based on the at least one pre-determined parameter. For instance, and as described briefly above, the system may—upon identifying and determining whether a pre-determined interruption parameter exists for an interruption and/or has been met for an interruption (e.g., a pre-defined maximum downtime)—update the Bi-Partite knowledge graph's interruption priority queue(s) with the associated interruption. In this manner, the at least one pre-determined parameter may be used to automatically shift up the interruption(s) with the pre-determined parameter.

In some embodiments, the pre-defined maximum downtime may be rated highest of the pre-determined interruption parameters, whereby any interruption that has already met its pre-defined maximum downtime may automatically be rated the highest in the interruption priority queue and resolved next. In some embodiments, and where an interruption comprises all the pre-determined interruption parameters (including a highest pre-defined priority), the associated interruption may be automatically rated highest in the interruption priority queue and resolved next.

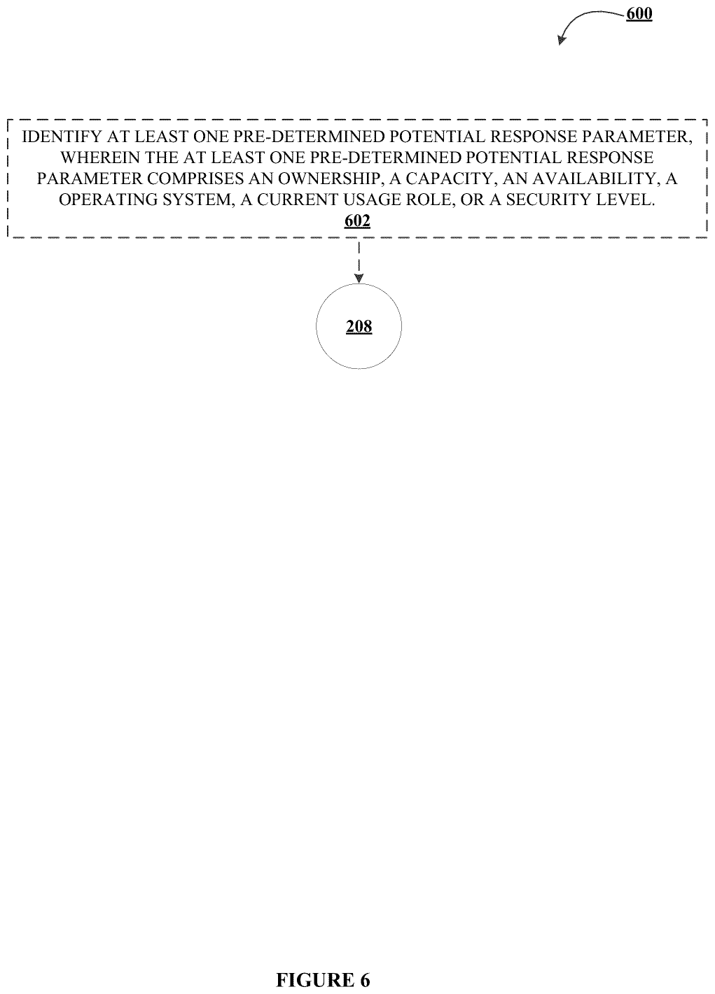

FIG. 6 illustrates a process flow 600 for identifying a pre-determined potential response parameter, in accordance with an embodiment of the disclosure. In some embodiments, a system (e.g., similar to one or more of the systems described herein with respect to FIGS. 1A-1C and 2) may perform one or more of the steps of process flow 600. For example, a system (e.g., the system 130 described herein with respect to FIG. 1A-1C) may perform the steps of process 600.

In some embodiments, and as shown in block 602, the process flow 600 may include the step of identifying at least one pre-determined potential response parameter, wherein the at least one pre-determined potential response parameter comprises an ownership, a capacity, an availability, a operating system, a current usage role, and/or a security level. For example, and in some embodiments, the system may identify at least one pre-determined potential response parameter, whereby the system may determine whether a potential response computing components is associated with at a pre-determined potential response parameter, which may in turn cause the priority level of the potential response computing component to shift up or down in the response priority queue.

As used herein, the ownership parameter refers to an ownership of the potential response computing component, such as an ownership by a particular entity within a client and/or an ownership outside of a client's system. In some embodiments, the ownership parameter may be used to determine which potential response computing components should be used in resolving an interruption. For instance, and where an interruption is comprised within computing component owned by an entity within a client, then the system may determine the ownership parameter as the same entity within the client. Thus, and in some embodiments, the same affected entity of the interruption may control the potential response computing component, thereby promoting a more efficient and secure process for resolving the interruption.

As used herein, the capacity parameter refers to the storage and transaction processing of the potential response computing components, whereby once a capacity parameter has been reached (e.g., indicating that the potential response computing component cannot handle more storage or transaction processing instances), then the system may not use the associated potential response computing component.

As used herein, the availability parameter refers to the likelihood the potential response computing component is available at a given time (e.g., a runtime divided by the total downtime and runtime, which indicates the amount of time the device is operating as a percentage of total time it should be operating). In this manner, and by determining the availability parameter, if the availability parameter indicates the potential response computing component is not operating currently or likely not operating currently, then the system may shift down the potential response computing component within the response priority queue.

As used herein, the operating system (OS) parameter refers to the operating system used by the potential response computing component and whether a particular OS should be used in resolving the interruption. For instance, and where the OS of the potential response computing component is obsolete, outdated, and/or the like. In some embodiments, only supporting operating systems may be used for resolving interruptions, and such supporting operating systems may be determined based on the operating system parameters defined for each potential response computing component. Thus, and by way of example, the system may determine particular operating systems that can be used for resolving interruptions, and the operating system parameters may be compared against the system determined operating systems.

As used herein, the current usage role parameter refers to the roles and privileges assigned to each potential response computing component, which indicates the responsibility(ies) and capabilities for each potential response computing component. In some embodiments, the current usage role parameter may be used by the system to determine which potential response computing component(s) have the capabilities and privileges to resolve an interruption. In some embodiments, each interruption and its impacted application(s) may require particular privileges and/or capabilities to resolve the interruption, whereby such privileges and/or capabilities may be matched with the current usage role parameter(s).

As used herein, the security level parameter refers to the security level required for the potential response computing component to be interacted with and used for resolving an interruption. In this manner, the system may determine which potential response computing component to shift up within the response priority queue based on determining which potential response computing component has the lowest security level(s) and/or which potential response computing component is available and unsecure due to having the proper security protocols met by authentication credentials already input.

Thus, and in some embodiments, the pre-determined potential response parameter(s) may be used by the system to shift up and/or shift down the potential response computing components are best to handle and resolve the interruption(s). In other words, and upon determining whether a pre-determined potential response parameter is present and identifying the pre-determined potential response parameter, the system update the Bi-Partite knowledge graph with the at least one interruption priority queue based on the at least one pre-determined parameter.

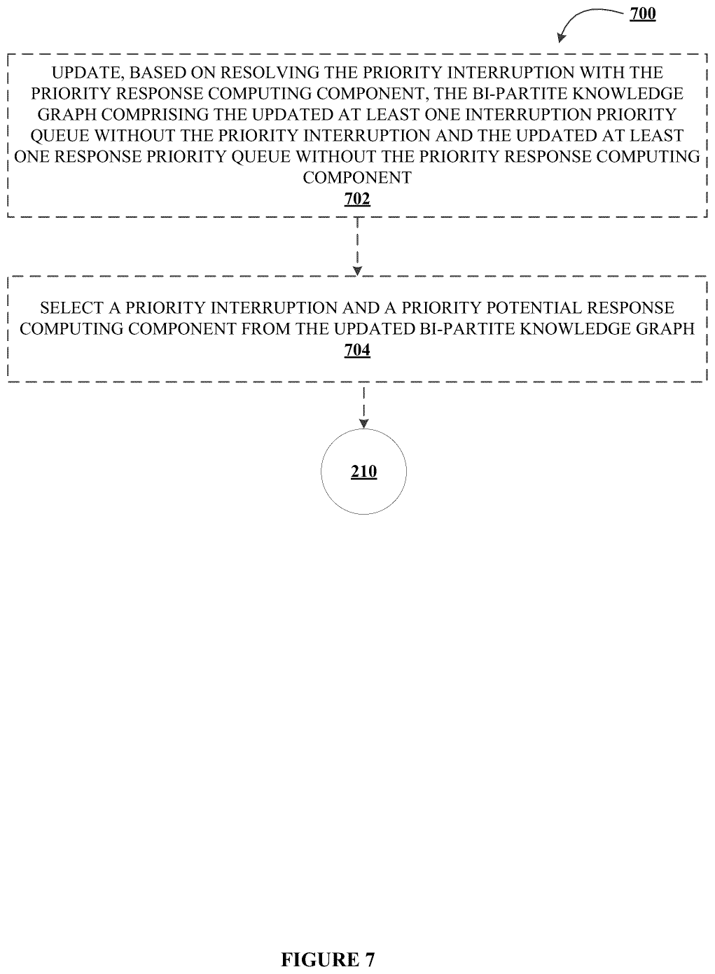

FIG. 7 illustrates a process flow 700 for selecting a priority interruption and a priority potential response computing component from an updated Bi-Partite knowledge graph, in accordance with an embodiment of the disclosure. In some embodiments, a system (e.g., similar to one or more of the systems described herein with respect to FIGS. 1A-1C and 2) may perform one or more of the steps of process flow 700. For example, a system (e.g., the system 130 described herein with respect to FIG. 1A-1C) may perform the steps of process 700.

In some embodiments, and as shown in block 702, the process flow 700 may include the step of updating—based on resolving the priority interruption with the priority response computing component—the Bi-Partite knowledge graph comprising the updated at least one interruption priority queue without the priority interruption and the updated at least one response priority queue without the priority response computing component. For example, the system may update—based on resolving at least a first priority interruption (such as that described with respect to block 210)—the interruption priority queue to identify a new priority interruption. In this manner, the system and its Bi-Partite knowledge graph may dynamically, automatically, and regularly update itself and its interruption priority queue to identify a new priority interruption to be resolved once a previous priority interruption has been resolved. Similarly, and based on resolving the previous priority interruption with the priority response computing component, the system and its Bi-Partite knowledge graph may update its priority response queue with a new priority response computing component dynamically, automatically, and regularly.

In some embodiments, the interruption priority queue and the response priority queue may be updated based on identifying new and/or updated interruption factor(s) and new and/or updated potential response factor(s). Such data for each of these factors may be identified and collected in real-time and as they occur (asynchronously). In some embodiments, and upon collecting the updated interruption factor(s) and/or the updated potential response factor(s), the system may synchronously update the interruption priority queue and/or the response priority queue based on such factors.

In some embodiments, and a shown in block 704, the process flow 700 may include the step of selecting a priority interruption and a priority potential response computing component from the updated Bi-Partite knowledge graph. For example, and in some embodiments, the system may select the priority interruption and the priority potential response computing component based on the updated Bi-Partite knowledge graph with the updated interruption priority queue and the response priority queue.

FIGS. 8A-8B illustrates exemplary Bi-Partite knowledge graphs 800 and 850, in accordance with an embodiment of the disclosure. In some embodiments, a system (e.g., similar to one or more of the systems described herein with respect to FIGS. 1A-1C and 2) may perform one or more of the steps for generating and updating Bi-Partite knowledge graphs 800 and 850. For example, a system (e.g., the system 130 described herein with respect to FIG. 1A-1C) may perform the steps for generating and updating Bi-Partite knowledge graphs 800 and 850.

As shown in exemplary Bi-Partite knowledge graph 800, one side of the Bi-Partite knowledge graph may comprise all the interruptions (i.e., events) and one side may comprise all the potential response computing components (i.e., set of technology infrastructure (TI) resources), which a relational edge between each side of the Bi-Partite knowledge graph. Further, and as shown in exemplary Bi-Partite knowledge graph 850, the set of all interruptions within the Bi-Partite knowledge graph may be updated regularly and dynamically with its interruption parameters (e.g., root cause analysis parameter, assigned and computed priority, time to resolution which may comprise workarounds, and/or the like). Additionally, and as shown in exemplary Bi-Partite knowledge graph 850, the set of potential response computing components may be updated regularly and dynamically based on its potential response factor(s) (e.g., types of available resources, availability and bandwidth, ownership, capacity, cloud-based, and/or the like). Further, at least one relational edge may be shared between each side of the Bi-Partite knowledge graph (e.g., from the interruptions a “request for a resource to resolve the interruption/problems” and from the potential response computing components an “assignment of resource to the interruption”).

Additionally, and in some embodiments like those described herein, a tree-balancing algorithm or method may be used to balance the dynamic trees on each side of the Bi-Partite knowledge graph. For instance, and in some embodiments, a red-black tree (which may be considered one of the most efficient tree balancing algorithm known in the art) may be used to keep the dynamic tree(s) always balanced so that the priority levels and/or values within the interruption priority queue and the response priority queue can be updated and reformatted quickly, efficiently, and automatically. Such a red-black tree comprises a binary search tree data structure which is used for fast storage capabilities and quick retrieval of information capabilities, which further ensures that the operations for each of the dynamic trees are completed in a known and expected period of time. Further, and as part of the red-black tree, each dynamic tree may be colored (such as red or black) and each time the dynamic trees must be re-arranged the assigned colors are determined and “painted” quickly and efficiently while maintaining the balance of the dynamic trees.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining and resolving interruptions to computing components, the system comprising:
a memory device with computer-readable program code stored thereon;
at least one processing device operatively coupled to the at least one memory device and the at least one communication device, wherein executing the computer-readable code is configured to cause the at least one processing device to:
identify at least one interruption and at least one potential response computing component;
generate a Bi-Partite knowledge graph comprising the at least one interruption within at least one interruption priority queue and the at least one potential response computing component within at least one response priority queue, wherein the Bi-Parte knowledge graph comprises a relational edge between the at least one interruption priority queue and the at least one response priority queue;
dynamically update the Bi-Partite knowledge graph with the at least one interruption priority queue based on at least one interruption factor and the at least one response priority queue based on at least one potential response factor;
select, based on the updated at least one interruption priority queue and the updated at least one response priority queue, a priority interruption and a priority potential response computing component; and
resolve the priority interruption with the priority response computing component.

2. The system of claim 1, wherein the at least one interruption is associated with at least one computing component.

3. The system of claim 1, wherein executing the computer-readable code is configured to cause the at least one processing device to:
identify a pre-defined priority for the at least one interruption; and
update the Bi-Partite knowledge graph with the at least one interruption priority queue based on the pre-defined priority.

4. The system of claim 1, wherein executing the computer-readable code is configured to cause the at least one processing device to:
determine whether the at least one interruption is associated with a plurality of interruptions; and
shift up, in an instance where the at least one interruption is associated with the plurality of interruptions, the at least one interruption in the at least one interruption priority queue.

5. The system of claim 1, wherein the at least one interruption factor comprises an assigned priority, a computed priority, a workaround, time to resolution, previous responses, or a root cause analysis.

6. The system of claim 1, wherein the at least one potential response factor comprises a current usage, an available capacity, a system stability, a required and a scheduled maintenance, an obsolescence, or a vulnerability.

7. The system of claim 1, wherein executing the computer-readable code is configured to cause the at least one processing device to:
identify at least one pre-determined interruption parameter for the at least one interruption, wherein the at least one pre-determined interruption parameter comprises at least one application impacted, a pre-defined priority, or a pre-defined maximum downtime; and
update the Bi-Partite knowledge graph with the at least one interruption priority queue based on the at least one pre-determined parameter.

8. The system of claim 1, wherein executing the computer-readable code is configured to cause the at least one processing device to:
identify at least one pre-determined potential response parameter, wherein the at least one pre-determined potential response parameter comprises an ownership, a capacity, an availability, an operating system, a current usage role, or a security level.

9. The system of claim 1, wherein the Bi-Partite knowledge graph comprises a plurality of interruption priority queues and a plurality of response priority queues.

10. The system of claim 1, wherein executing the computer-readable code is configured to cause the at least one processing device to:
update, based on resolving the priority interruption with the priority response computing component, the Bi-Partite knowledge graph comprising the updated at least one interruption priority queue without the priority interruption and the updated at least one response priority queue without the priority response computing component; and
select a priority interruption and a priority potential response computing component from the updated Bi-Partite knowledge graph.

11. A computer program product for determining and resolving interruptions to computing components, wherein the computer program product comprises at least one non-transitory computer-readable medium having computer-readable program code portions embodied therein, the computer-readable program code portions which when executed by a processing device are configured to cause the processor to:
identify at least one interruption and at least one potential response computing component;
generate a Bi-Partite knowledge graph comprising the at least one interruption within at least one interruption priority queue and the at least one potential response computing component within at least one response priority queue, wherein the Bi-Parte knowledge graph comprises a relational edge between the at least one interruption priority queue and the at least one response priority queue;
dynamically update the Bi-Partite knowledge graph with the at least one interruption priority queue based on at least one interruption factor and the at least one response priority queue based on at least one potential response factor;
select, based on the updated at least one interruption priority queue and the updated at least one response priority queue, a priority interruption and a priority potential response computing component; and
resolve the priority interruption with the priority response computing component.

12. The computer program product of claim 11, wherein the at least one interruption is associated with at least one computing component.

13. The computer program product of claim 11, wherein the at least one interruption factor comprises an assigned priority, a computed priority, a workaround, time to resolution, previous responses, or a root cause analysis.

14. The computer program product of claim 11, wherein the at least one potential response factor comprises a current usage, an available capacity, a system stability, a required maintenance, a scheduled maintenance, an obsolescence, or a vulnerability.

15. The computer program product of claim 11, wherein the Bi-Partite knowledge graph comprises a plurality of interruption priority queues and a plurality of response priority queues.

16. A computer-implemented method for determining and resolving interruptions to computing components, the computer-implemented method comprising:
identifying at least one interruption and at least one potential response computing component;
generating a Bi-Partite knowledge graph comprising the at least one interruption within at least one interruption priority queue and the at least one potential response computing component within at least one response priority queue, wherein the Bi-Parte knowledge graph comprises a relational edge between the at least one interruption priority queue and the at least one response priority queue;
dynamically updating the Bi-Partite knowledge graph with the at least one interruption priority queue based on at least one interruption factor and the at least one response priority queue based on at least one potential response factor;
selecting, based on the updated at least one interruption priority queue and the updated at least one response priority queue, a priority interruption and a priority potential response computing component; and
resolving the priority interruption with the priority response computing component.

17. The computer-implemented method of claim 16, wherein the at least one interruption is associated with at least one computing component.

18. The computer-implemented method of claim 16, wherein the at least one interruption factor comprises an assigned priority, a computed priority, a workaround, time to resolution, previous responses, or a root cause analysis.

19. The computer-implemented method of claim 16, wherein the at least one potential response factor comprises a current usage, an available capacity, a system stability, a required maintenance, a scheduled maintenance, an obsolescence, or a vulnerability.

20. The computer-implemented method of claim 16, wherein the Bi-Partite knowledge graph comprises a plurality of interruption priority queues and a plurality of response priority queues.
